(19) United States
(12) Patent Application Publication
(10) Pub. No.: US 2025/0244920 A1
(43) Pub. Date: Jul. 31, 2025

(54) INFORMATION PROCESSING SYSTEM, INFORMATION PROCESSING APPARATUS, AND RECORDING MEDIUM

(71) Applicants: Ryonosuke MIYAZAKI, Tokyo (JP); Hiroki YAMAMURA, Tokyo (JP)

(72) Inventors: Ryonosuke MIYAZAKI, Tokyo (JP); Hiroki YAMAMURA, Tokyo (JP)

(21) Appl. No.: 19/035,453

(22) Filed: Jan. 23, 2025

(30) Foreign Application Priority Data
Jan. 25, 2024 (JP) 2024-009520

(51) Int. Cl. G06F 3/12

(52) U.S. Cl. CPC G06F 3/121; G06F 3/1273

(57) ABSTRACT

An information processing system includes a memory and circuitry. The memory stores first information relating to an offer target and acquired from the offer target and second information relating to the offer target and acquired from a source other than the offer target. The circuitry specifies an offering model relating to the offer target based on the first information and the second information.

### CROSS-REFERENCE TO RELATED APPLICATIONS

This patent application is based on and claims priority pursuant to 35 U.S.C. § 119(a) to Japanese Patent Application No. 2024-009520, filed on Jan. 25, 2024, in the Japan Patent Office, the entire disclosure of which is hereby incorporated by reference herein.

### BACKGROUND

### Technical Field

Embodiments of the present disclosure relate to an information processing system, an information processing apparatus, and a recording medium.

### Related Art

A background information processing system and information processing method introduce an application that is usable by an apparatus.

However, the background information processing system and information processing method do not provide a service that identifies and solves an issue faced by a customer using the apparatus.

### SUMMARY

According to an embodiment of the present disclosure, an information processing system includes a memory and circuitry. The memory stores first information relating to an offer target and acquired from the offer target and second information relating to the offer target and acquired from a source other than the offer target. The circuitry specifies an offering model relating to the offer target based on the first information and the second information.

According to an embodiment of the present disclosure, an information processing apparatus includes circuitry. The circuitry manages first information relating to an offer target and acquired from the offer target and second information relating to the offer target and acquired from a source other than the offer target, and specifies an offering model relating to the offer target based on the first information and the second information. The offer target is connected to the information processing apparatus via a network.

According to an embodiment of the present disclosure, a non-transitory recording medium stores a plurality of instructions which, when executed by one or more processors, causes the processors to perform a method including managing first information relating to an offer target and acquired from the offer target and second information relating to the offer target and acquired from a source other than the offer target, and specifying an offering model relating to the offer target based on the first information and the second information. The offer target is connected via a network.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a schematic hardware configuration of an information processing system according to an embodiment;

FIGS. 2A and 2B are diagrams illustrating hardware configurations of apparatuses included in the information processing system illustrated in FIG. 1;

FIG. 3 is a block diagram of software included in a server apparatus according to the embodiment;

FIG. 4 is a table illustrating an example of customer information;

FIG. 5 is a table illustrating an example of inquiry history information;

FIG. 6 is a table illustrating an example of offering model information;

FIG. 7 is a table illustrating an example of a proposal history;

FIG. 8 is a flowchart illustrating an example of processing performed by the server apparatus illustrated in FIG. 3;

FIG. 9 is a view illustrating an example of a screen for a process of proposing a solution;

FIG. 10 is a view illustrating an example of a screen that presents an offering model to a sales representative;

FIG. 11 is a view illustrating an example of a screen that indicates the operation status; and

FIG. 12 is a view illustrating an example of a screen that presents an offering model to a customer.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

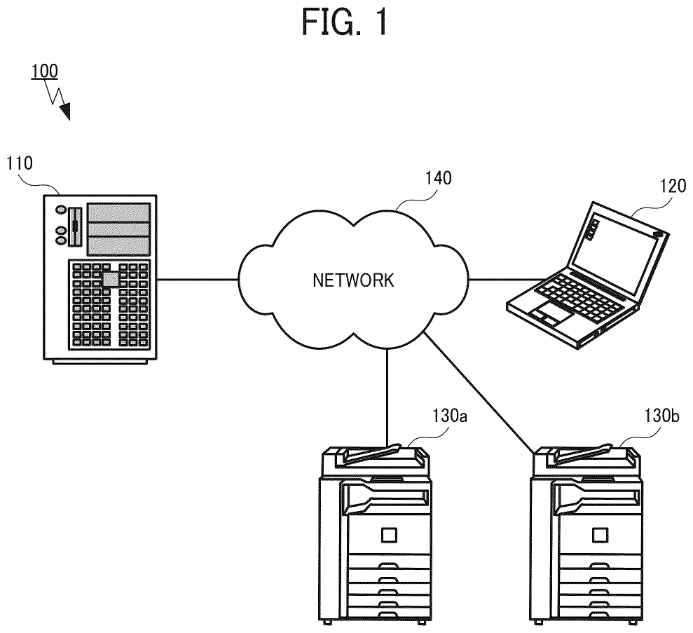

FIG. 1 is a diagram illustrating a schematic hardware configuration of an information processing system 100 according to the present embodiment. In an example environment illustrated in FIG. 1, the information processing system 100 includes a server apparatus 110, a terminal apparatus 120, and image forming apparatuses 130a and 130b, which are connected to each other via a network 140 such as the Internet or a local area network (LAN). Hereinafter, the image forming apparatuses 130a and 130b may be collectively referred to as an “image forming apparatus 130.” Although the two image forming apparatus 130a and 130b are illustrated in FIG. 1, the number of image forming apparatuses 130 included in the information processing system 100 is not limited thereto. Further, the apparatuses included in the information processing system 100 may be connected to the network 140 via a wire or wirelessly.

The server apparatus 110 is, for example, an information processing apparatus such as a server computer that provides various services in the present embodiment. For example, the server apparatus 110 according to the present embodiment analyzes the operation status of the image forming apparatus 130 used by a customer and an inquiry from the customer to propose an offering model that matches the customer's needs. In the present embodiment, the term “offering model” refers to an additional function to be proposed to a customer using the image forming apparatus 130 to solve an issue faced by the customer. However, the offering model is not particularly limited thereto. The offering model may be, for example, a setting value such as a price, a service, or a solution.

The terminal apparatus 120 is, for example, an information processing apparatus such as a personal computer. For example, the terminal apparatus 120 according to the present embodiment is used by a sales representative of a business operator providing an offering model and proposes the offering model to a customer using the image forming apparatus 130 based on the analysis result of the server apparatus 110. Hereinafter, the sales representative of the business operator providing an offering model may be occasionally simply referred to as a “sales representative.”

The image forming apparatus 130 executes print jobs received from various information processing apparatuses to form images. For example, the image forming apparatus 130 according to the present embodiment receives a proposal for an offering model and adds a function relating to the offering model either as hardware or software. In one example, when an offering model is proposed to a customer and the customer applies to purchase the offering model, a function relating to the offering model may be added to the image forming apparatus 130. In the present embodiment, the image forming apparatus 130 is an example of a target that receives a proposal for an offering model. Hereinafter, the target that receives a proposal for an offering model may be referred to as an “offer target.” Note that the offer target is not particularly limited to the image forming apparatus 130. Any target other than the image forming apparatus 130 may receive a proposal for an offering model and add the offering model thereto.

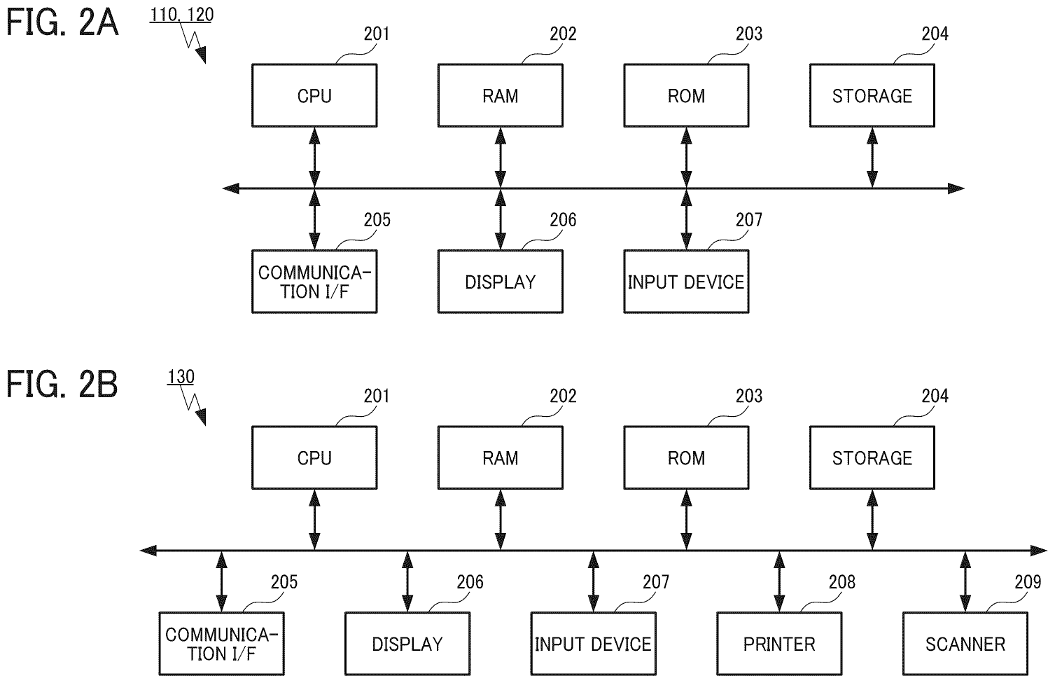

Hardware configurations of the apparatuses included in the information processing system 100 are described with reference to FIGS. 2A and 2B. FIGS. 2A and 2B are diagrams illustrating the hardware configurations of the apparatuses included in the information processing system 100 according to the present embodiment. Specifically, FIG. 2A illustrates the hardware configuration of the server apparatus 110 and the terminal apparatus 120. FIG. 2B illustrates the hardware configuration of the image forming apparatus 130.

Each of the server apparatus 110 and the terminal apparatus 120 illustrated in FIG. 2A includes a central processing unit (CPU) 201, a random-access memory (RAM) 202, a read-only memory (ROM) 203, a storage 204, a communication interface (I/F) 205, a display 206, and an input device 207. These hardware components are connected to each other via a bus.

The CPU 201 executes programs that control the operation of the server apparatus 110 or the terminal apparatus 120 and performs predetermined processing. The RAM 202 is a volatile storage that provides a work area where the CPU 201 executes programs and is used to store and deploy programs and data therein. The ROM 203 is a non-volatile storage that stores, for example, programs and firmware that are executed by the CPU 201.

The storage 204 is a readable and writable non-volatile storage that stores, for example, an operating system (OS), various software, setting information, and various data that cause the server apparatus 110 or the terminal apparatus 120 to function. Examples of the storage 204 include a hard disk drive (HDD) and a solid-state drive (SSD).

The communication I/F 205 connects the server apparatus 110 or the terminal apparatus 120 to the network 140 and enables the server apparatus 110 or the terminal apparatus 120 to communicate with another apparatus via the network 140. Communication via the network 140 may be performed either via a wire or wirelessly. The communication I/F 205 transmits and receives various data using a predetermined communication protocol such as a transmission control protocol/internet protocol (TCP/IP).

The display 206 displays, for example, various data and the status of the server apparatus 110 or the terminal apparatus 120 to a user and is implemented by, for example, a liquid-crystal display (LCD). The input device 207 receives the user's operation of various apparatuses or devices. Examples of the input device 207 include a keyboard and a mouse. The display 206 and the input device 207 may be separate devices or may be integrated as a single device such as a touch panel display having both functions of the display 206 and the input device 207. The server apparatus 110 may not include the display 206 and the input device 207.

The image forming apparatus 130 illustrated in FIG. 2B includes the CPU 201, the RAM 202, the ROM 203, the storage 204, the communication I/F 205, the display 206, the input device 207, a printer 208, and a scanner 209. These hardware components are connected to each other via a bus. Since the CPU 201, the RAM 202, the ROM 203, the storage 204, the communication I/F 205, the display 206, and the input device 207 are the same or substantially the same as those described in FIG. 2A, detailed descriptions thereof are omitted below.

The printer 208 forms an image on a sheet of paper using a laser system or an inkjet system. The scanner 209 reads a printed matter and generates image data. The image forming apparatus 130 uses the scanner 209 and the printer 208 to make a copy of the printed matter.

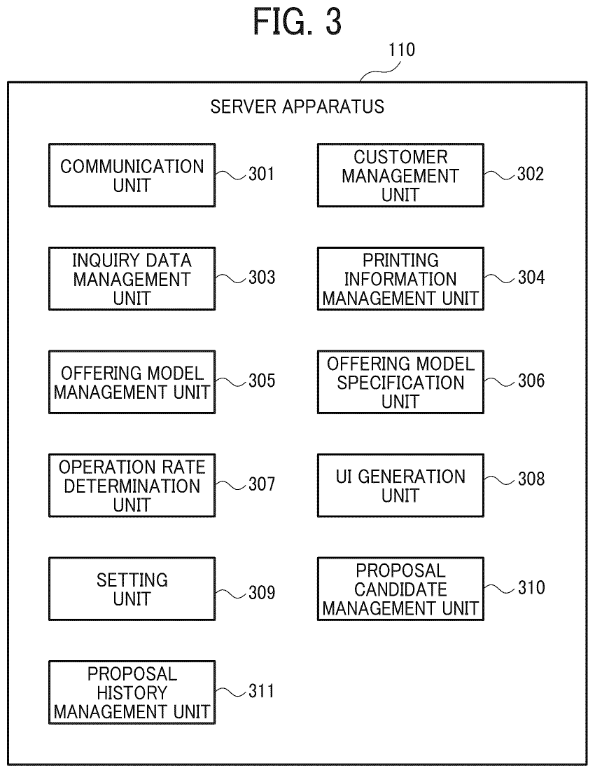

The hardware configurations of the apparatuses included in the information processing system 100 according to the present embodiment have been described above. Next, a function executed by corresponding one or more of the hardware components of the server apparatus 110 in the information processing system 100 is described below with reference to FIG. 3. FIG. 3 is a block diagram of software that executes the function of the server apparatus 110.

The server apparatus 110 includes modules including a communication unit 301, a customer management unit 302, an inquiry data management unit 303, a printing information management unit 304, an offering model management unit 305, an offering model specification unit 306, an operation rate determination unit 307, a user interface (UI) generation unit 308, a setting unit 309, a proposal candidate management unit 310, and a proposal history management unit 311. The details of these modules are described below.

The communication unit 301 controls the operation of the communication I/F 205 to communicate with each apparatus included in the information processing system 100 via the network 140. For example, the communication unit 301 receives the operation status of the image forming apparatus 130 and transmits a UI for proposing an offering model to the terminal apparatus 120 or the image forming apparatus 130.

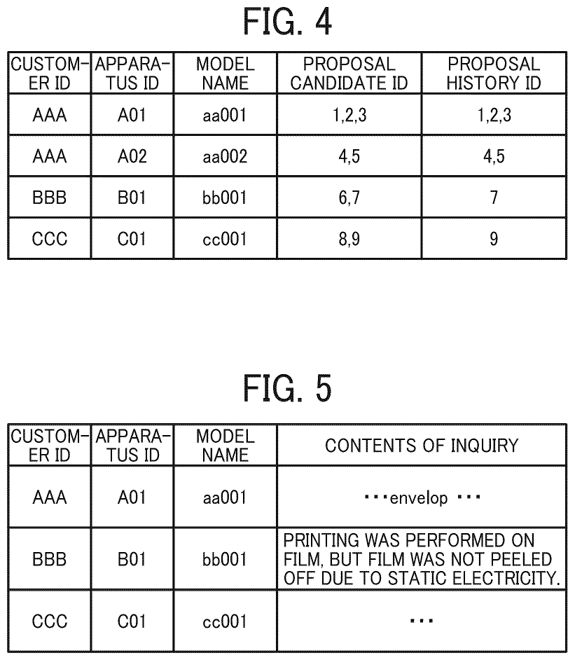

The customer management unit 302 controls the operation of the storage 204 to manage information regarding each customer who uses the image forming apparatus 130. For example, the customer management unit 302 stores, in the storage 204, customer information illustrated in FIG. 4 in a table format to manage each customer using the customer information. FIG. 4 illustrates an example of a customer information table.

As illustrated in FIG. 4, the customer management unit 302 stores an identifier (ID) that identifies a customer, an ID that identifies an apparatus owned by the customer, and the model name of the apparatus owned by the customer in association with each other. The customer information table may also include an ID (proposal candidate ID) that identifies a candidate offering model to be proposed to a corresponding apparatus. The customer information table may also include an ID (proposal history ID) that identifies an offering model that has been proposed, among candidate offering models to be proposed.

Referring back to FIG. 3, the inquiry data management unit 303 controls the operation of the storage 204 to manage the contents of an inquiry from a customer regarding an apparatus. For example, the inquiry data management unit 303 stores, in the storage 204, inquiry history information illustrated in FIG. 5 in a table format to manage inquiry data using the inquiry history information. FIG. 5 illustrates an example of an inquiry history information table.

As illustrated in FIG. 5, the inquiry data management unit 303 stores an ID that identifies a customer who has made an inquiry regarding an apparatus, an ID that identifies the apparatus relating to the inquiry, the model name of the apparatus, and the contents of the inquiry in association with each other. The inquiry history information table illustrated in FIG. 5 may be created according to inputs from an operator, for example. Alternatively, the table illustrated in FIG. 5 may be created by automatically transcribing the contents of an inquiry call using speech recognition, by automatically creating the contents of an inquiry from an inquiry email, or by converting a handwritten note into a text, for example. Although the inquiry data management unit 303 acquires and manages the inquiry contents in the present embodiment, the present disclosure is not particularly limited to the present embodiment. For example, in another embodiment, a functional unit corresponding to the inquiry data management unit 303 may manage information which relates to an offer target (in the present embodiment, the image forming apparatus 130) to which an offering model is to be provided and which has been acquired from a source other than the offer target. Hereinafter, information relating to an offer target and acquired from a source other than the offer target is referred to as “information acquired from a source other than the offer target” or “second information.”

Referring back to FIG. 3, the printing information management unit 304 acquires and manages, for example, the status and the operation history of the image forming apparatus 130 via the communication unit 301. In the present embodiment, since the information processing system 100 including the image forming apparatus 130 is illustrated as an example, the printing information management unit 304 acquires and manages, for example, the status and the operation history. In another embodiment, a functional unit corresponding to the printing information management unit 304 may manage information relating to an offer target and acquired from the offer target. Hereinafter, information relating to an offer target and acquired from the offer target is referred to as “information acquired from the offer target” or “first information.”

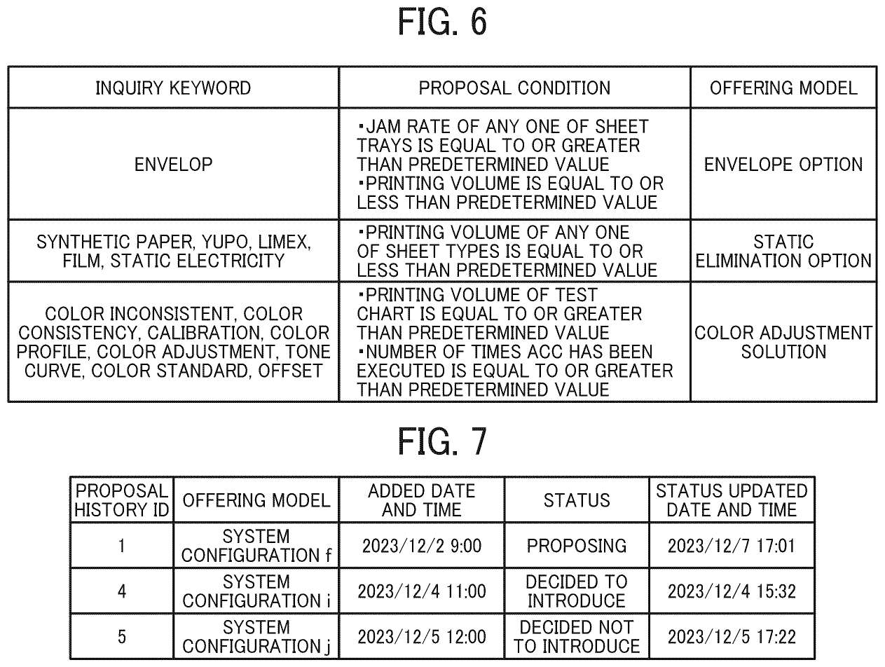

The offering model management unit 305 controls the operation of the storage 204 to manage data relating to an offering model. For example, the offering model management unit 305 stores, in the storage 204, offering model information illustrated in FIG. 6 in a table format to manage an offering model. FIG. 6 illustrates an example of an offering model information table.

As illustrated in FIG. 6, the offering model management unit 305 stores an inquiry keyword, a condition for proposing an offering model, and the offering model in association with each other. In the example illustrated in FIG. 6, when a customer's inquiry includes the term “envelop” and the jam rate of any of sheet trays of the image forming apparatus 130 used by the customer is equal to or greater than a predetermined threshold value, the server apparatus 110 proposes an envelope option to the customer as an offering model. With this configuration, the server apparatus 110 proposes an offering model that addresses the customer's issue and needs, taking into account the contents of the customer's inquiry and the operation status of the image forming apparatus 130. Further, as illustrated in FIG. 6, two or more proposal conditions may be set for a single inquiry keyword. This allows the server apparatus 110 to change the priority and recommendation level of an offering model to be proposed, thereby proposing the offering model more flexibly.

Referring back to FIG. 3, the offering model specification unit 306 analyzes the operation history and the contents of an inquiry to specify an offering model to be proposed to a customer. The offering model specification unit 306 analyzes, for example, the contents of an inquiry managed by the inquiry data management unit 303 and the operation status managed by the printing information management unit 304. The offering model specification unit 306 refers to the table illustrated in FIG. 6 based on the result of the analysis to specify an offering model to be proposed to a customer.

The operation rate determination unit 307 determines whether or not the operation rate is equal to or greater than a predetermined threshold value to determine the operation status managed by the printing information management unit 304.

The UI generation unit 308 generates a UI to be displayed on the display 206 of the terminal apparatus 120 or the image forming apparatus 130. For example, the UI generation unit 308 generates a screen UI to be displayed on the display 206 to propose an offering model specified by the offering model specification unit 306. The generated UI is transmitted to the terminal apparatus 120 or image forming apparatus 130 via the communication unit 301 and displayed on the display 206. For example, a sales representative of a business operator providing an offering model may view the UI displayed on the terminal apparatus 120 to recognize an offering model suitable for a customer and make an appropriate proposal to the customer. For example, the customer using the image forming apparatus 130 may view the UI displayed on the display 206 of the image forming apparatus 130 to recognize the proposed offering model and determine whether or not to introduce a function that helps to solve the customer's issue.

The setting unit 309 performs various settings for the server apparatus 110. For example, the setting unit 309 sets various threshold values that serve as conditions for proposing an offering model. The setting unit 309 may also, for example, set a display period (target period) for which a graph indicating the printing volume is displayed and store setting information indicating the set display period in the storage 204. In this case, the UI generation unit 308 generates screen information relating to a printing volume summary screen based on the setting information indicating the display period set by the setting unit 309.

The proposal candidate management unit 310 manages a candidate for an offering model to be proposed to a customer. Specifically, the proposal candidate management unit 310 manages an offering model specified by the offering model specification unit 306 as a candidate to be proposed to a customer. For example, when the offering model specification unit 306 has specified an offering model for a particular image forming apparatus 130, the proposal candidate management unit 310 issues a proposal candidate ID for the offering model and newly creates a table indicating proposal candidate information illustrated in FIG. 4.

The proposal history management unit 311 manages the history of a proposed offering model. In the present embodiment, the proposal candidate management unit 310 and the proposal history management unit 311 manage, for example, a proposal candidate ID and a proposal history ID in the table illustrated in FIG. 4. The proposal history management unit 311 manages the history of an offering model specified by the offering model specification unit 306 and proposed to a customer by a sales representative. Specifically, when the offering model specification unit 306 has specified an offering model for a particular image forming apparatus 130, a sales representative has proposed the offering model to a customer, and the customer has responded to the proposal, the proposal history management unit 311 issues a proposal history ID for the offering model and newly creates a record of proposal history information illustrated in FIG. 7.

FIG. 7 illustrates an example of a proposal history table. As illustrated in FIG. 7, the proposal history table stores an ID that identifies the proposal history, an offering model that has been specified and proposed to a customer, the proposed date and time, the status of the customer's response to the proposal, and the date and time when the status was updated, in association with each other.

The above-described software block corresponds to functional units implemented by the CPU 201 executing programs according to the present embodiment to cause each hardware to function. All the functional units described in the present embodiment may be implemented by software, or part or all of the functional units may be implemented as hardware providing equivalent functions.

The server apparatus 110 with the configuration illustrated in FIG. 3 does not necessarily include all of the functional units described above. For example, in another preferred embodiment, the server apparatus 110 and the terminal apparatus 120 may operate in cooperation to implement these functional units.

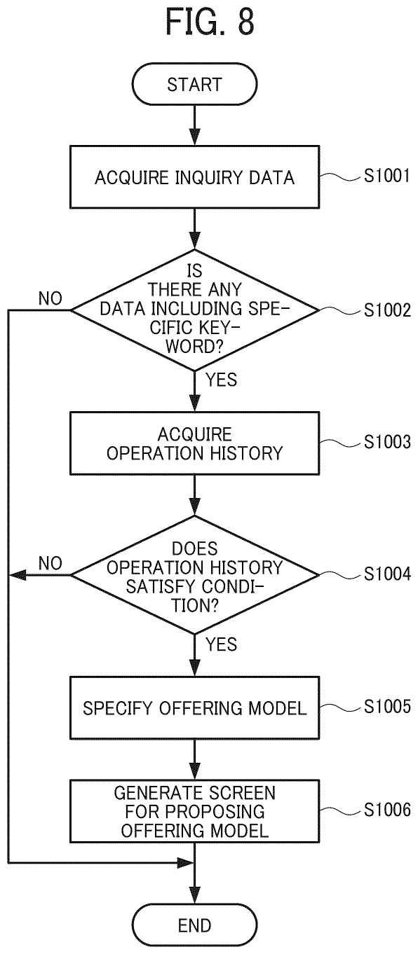

Next, the processing performed by the functional units described above is described with reference to FIG. 8. FIG. 8 is a flowchart illustrating an example of the processing according to the present embodiment.

The processing illustrated in the flowchart of FIG. 8 is mainly performed by one or more of the functional units of the server apparatus 110. The processing illustrated in FIG. 8 may start when, for example, a new offering model is added and registered. Further, the processing illustrated in the flowchart of FIG. 8 may start in response to, for example, the operation by a sales representative of a business operator providing an offering model or the operation by a customer using the image forming apparatus 130.

In step S1001, the offering model specification unit 306 refers to the table managed by the inquiry data management unit 303 to acquire inquiry data. In step S1002, the processing proceeds to one of the two paths depending on whether or not there is any inquiry data that includes a specific keyword. For example, the specific keyword may be an inquiry keyword in the table illustrated in FIG. 6. The specific keyword may be a keyword relating to an offering model. When there is no inquiry data that includes the specific keyword (NO in step S1002), the processing ends. When there is inquiry data that includes the specific keyword (YES in step S1002), the processing proceeds to step S1003.

In step S1003, the offering model specification unit 306 acquires the operation history of the image forming apparatus 130 from printing information managed by the printing information management unit 304. In step S1004, the processing proceeds to one of the two paths depending on whether or not the acquired operation history satisfies a predetermined condition. The predetermined condition serving as a determination criterion in step S1004 may be, for example, a proposal condition described in the table of FIG. 6. When the acquired operation history does not satisfy the predetermined condition (NO in step S1004), the processing ends. When the acquired operation history satisfies the predetermined condition (YES in step S1004), the processing proceeds to step S1005.

In step S1005, the offering model specification unit 306 specifies an offering model to be proposed based on the inquiry data and the operation history. A specific example of how the offering model is specified is described with reference to the tables illustrated in FIGS. 5 and 6. For example, when a “static elimination option” is added as an offering model to the table illustrated in FIG. 6, the offering model specification unit 306 refers to the table illustrated in FIG. 5 in step S1002 to determine whether or not there is any inquiry data that includes an inquiry keyword corresponding to the “static elimination option.” In this case, the table illustrated in FIG. 5 includes inquiry data that includes the keyword “static electricity,” which corresponds to the “static elimination option.” This inquiry data is associated with a model with an apparatus ID “B01” used by a customer with a customer ID “BBB.” Therefore, in step S1003, the offering model specification unit 306 acquires the operation history of the model with the apparatus ID “B01.” In step S1004, the offering model specification unit 306 determines whether or not the operation history satisfies a condition. The condition referred to as the determination criterion herein is “the printing volume of any of sheet types is equal to or less than a predetermined value,” which is described in the proposal condition corresponding to the “static elimination option” in the table illustrated in FIG. 6. When the printing volume of any of the sheet types of the model with the apparatus ID “B01” is equal to or less than the predetermined value (YES in step S1004), the offering model specification unit 306 specifies the “static elimination option” as the offering model to be proposed to the customer who uses the model with the apparatus “B01.” In this way, the offering model specification unit 306 according to the present embodiment specifies the offering model based on the inquiry data and the operation history. The offering model specification unit 306 notifies, for example, the UI generation unit 308 of the offering model proposed in step S1005.

In step S1006, the UI generation unit 308 generates a screen UI for proposing the offering model. The UI generated in step S1006 may be, for example, a UI for the sales representative of the business operator providing the offering model or a UI for the customer using the image forming apparatus 130. The generated UI is transmitted to the terminal apparatus 120 or the image forming apparatus 130 via the communication unit 301 to allow the sales representative or the customer to view the UI.

After that, the server apparatus 110 ends the processing.

Through the processing illustrated in FIG. 8, the server apparatus 110 proposes the offering model that is suitable for the customer, taking into account not only the operating history of the image forming apparatus 130 but also the contents of the customer's inquiry to, for example, a support desk.

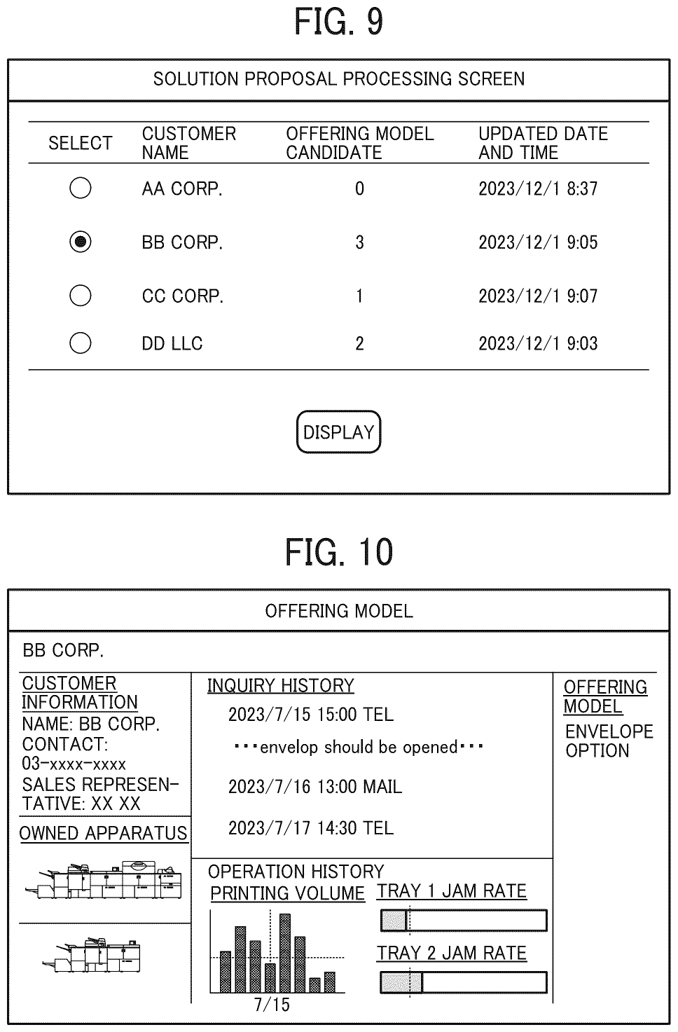

Various UI examples according to the present embodiment are described below with reference to FIGS. 9 to 12.

FIG. 9 is a view illustrating an example of a screen for a process of proposing a solution according to the present embodiment. Specifically, FIG. 9 illustrates an example of a UI displayed on the terminal apparatus 120 operated by a sales representative. This UI is a screen which is displayed when a process of proposing an offering model suitable for a customer is performed. The sales representative operates the screen illustrated in FIG. 9 to select a customer and presses a display button to request the server apparatus 110 to perform a process of specifying an offering model. In other words, pressing the display button on the screen illustrated in FIG. 9 causes the server apparatus 110 to start the processing illustrated in the flowchart of FIG. 8.

FIG. 10 is a view illustrating an example of a screen that presents an offering model to the sales representative. The screen illustrated in FIG. 10 is an example of a UI which is displayed on the terminal apparatus 120 operated by the sales representative. The UI illustrated in FIG. 10 is generated by the UI generation unit 308 in step S1006 of FIG. 8. The UI illustrated in FIG. 10 displays, for example, information regarding an offering model to be proposed to the customer, the contents of the history of customer's inquiries, and the operation history of an apparatus owned by the customer. The operation history displayed herein includes, for example, the printing volume of the image forming apparatus 130 and the jam rate of each sheet tray. The sales representative grasps the offering model suitable for the customer by viewing the screen illustrated in FIG. 10 and utilizes the offering model in sales activities.

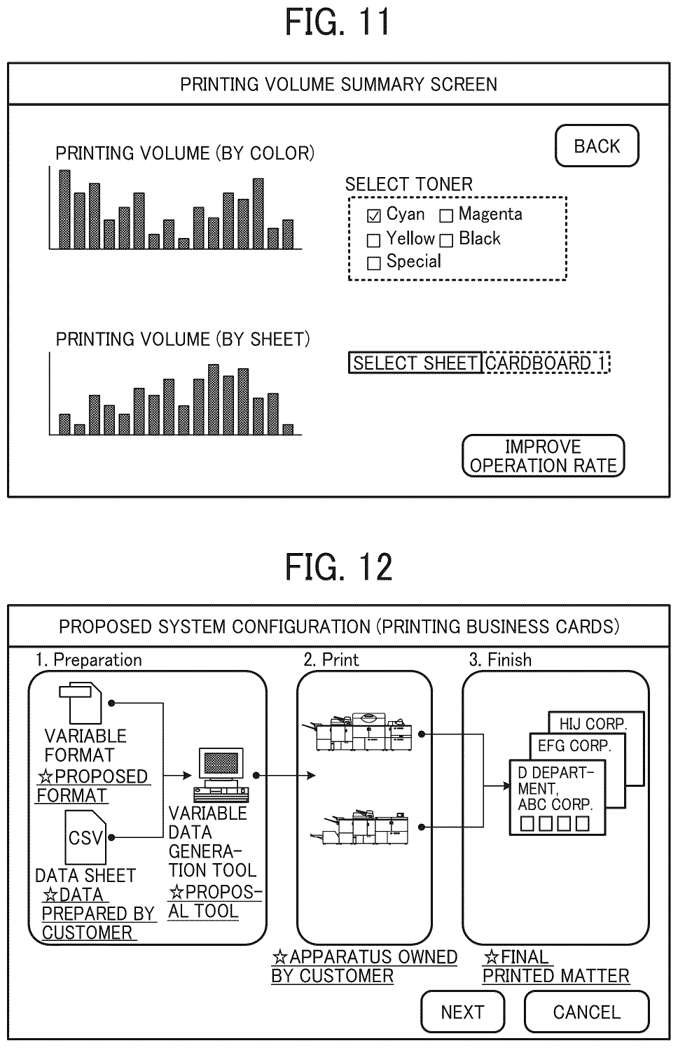

FIG. 11 is a view illustrating an example of a screen that indicates the operation status. The screen illustrated in FIG. 11 is an example of a UI displayed on the image forming apparatus 130 owned by the customer. As an example, FIG. 11 illustrates a graph indicating the printing volume for each time period. The customer grasps the operation history of the image forming apparatus 130 owned by the customer by viewing the screen illustrated in FIG. 11. In one example, the customer may press an “Improve operation rate” button on the screen illustrated in FIG. 11 to request the server apparatus 110 to perform the process of specifying an offering model and receive a proposal for the offering model that enables a more efficient operation of the image forming apparatus 130 owned by the customer. In other words, pressing the “Improve operation rate” button on the screen illustrated in FIG. 10 causes the server apparatus 110 to start the processing illustrated in the flowchart of FIG. 8.

FIG. 12 is a view illustrating an example of a screen that presents an offering model to the customer. The screen illustrated in FIG. 12 is, for example, displayed on the image forming apparatus 130 owned by the customer. The UI illustrated in FIG. 12 is generated by the UI generation unit 308 in step S1006 of FIG. 8. The UI illustrated in FIG. 12 displays information such as a detailed configuration of the offering model to be proposed and the use of the offering model. The customer recognizes an option function suitable for the image forming apparatus 130 owned by the customer by viewing the UI illustrated in FIG. 12. The UI displayed for the customer may include information such as the operation history illustrated in the UI of FIG. 10, in addition to the information illustrated in FIG. 12.

One or more embodiments of the present disclosure provide an information processing system, an information processing apparatus, and a program stored in a recording medium, each of which proposes an offering model for solving a customer's issue.

In the above-described embodiments, the information processing system 100 includes the image forming apparatus 130 and an offering model is proposed to the image forming apparatus 130 serving as an offer target. However, the present disclosure is not particularly limited to the above-described embodiments. In another embodiment, the information processing system 100 having the configuration according to the above-described embodiments may be a system that acquires the sales volume of a product in a point-of-sale (POS) system as the information acquired from an offer target, acquires the inventory status of the product as the information acquired from a source other than the offer target, and provides an appropriate price as an offering model. Further, the information processing system 100 having the configuration according to the above-described embodiments may be applied to, for example, fields such as finance, human resources, sales, digital marketing, insurance, and construction management and maintenance.

For example, when the information processing system 100 having the configuration according to the above-described embodiments is applied to the field of finance, account information may be the information acquired from an offer target, and information including the contents of consultations at, for example, a bank counter may be the information acquired from a source other than the offer target. In another example, when the information processing system 100 having the configuration according to the above-described embodiments is applied to the field of human resources, job offer data may be the information acquired from an offer target, and information during an interview may be the information acquired from a source other than the offer target.

Each of the functions according to the above-described embodiments of the present disclosure may be implemented by an apparatus-executable program written in, for example, C, C++, C#, or Java™. The programs according to the above-described embodiments of the present disclosure may be stored in an apparatus-readable recording medium and distributed. Examples of the apparatus-readable recording medium include an HDD, a compact disc-read-only memory (CD-ROM), a magneto-optical disk (MO), a digital versatile disk (DVD), a flexible disk, an electrically erasable programmable read-only memory (EEPROM™), and an erasable programmable read-only memory (EPROM). The programs according to the above-described embodiments of the present disclosure may be transmitted over a network in a format installable by another apparatus.

Various tables and offering models to be proposed in the above-described embodiments may be generated by machine learning. Machine learning classifies keywords that would otherwise be included in the items of the tables, eliminating the use of the correspondence tables.

Machine learning herein refers to a technique that enables a computer to acquire a human-like learning ability. Specifically, machine learning refers to a technique that enables a computer to autonomously generate an algorithm to be used for determination such as data identification from training data input to the computer in advance and apply the generated algorithm to new data to make a prediction. Machine learning may employ any learning method such as supervised learning, unsupervised learning, semi-supervised learning, reinforcement learning, deep learning, or any combination of these learning methods.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing system comprising:
a memory that stores:
first information relating to an offer target and acquired from the offer target; and
second information relating to the offer target and acquired from a source other than the offer target; and
circuitry configured to specify an offering model relating to the offer target based on the first information and the second information.

2. The information processing system according to claim 1, wherein the circuitry is configured to store the offering model in the memory in association with the first information and the second information.

3. The information processing system according to claim 1, wherein the circuitry is configured to generate a screen for proposing the specified offering model.

4. The information processing system according to claim 3, wherein the circuitry is configured to transmit information relating to the generated screen to the offer target.

5. The information processing system according to claim 3, wherein the circuitry is configured to transmit information relating to the generated screen to an information processing apparatus used by a business operator providing the offering model.

6. The information processing system according to claim 1, wherein the offer target includes an image forming apparatus.

7. The information processing system according to claim 6,
wherein the first information includes information relating to a usage history of the image forming apparatus, and
the second information includes inquiry data relating to the image forming apparatus.

8. An information processing apparatus comprising circuitry configured to:
manage first information relating to an offer target and acquired from the offer target and second information relating to the offer target and acquired from a source other than the offer target, the offer target being connected to the information processing apparatus via a network; and
specify an offering model relating to the offer target based on the first information and the second information.

9. A non-transitory recording medium storing a plurality of instructions which, when executed by one or more processors, causes the processors to perform a method comprising:
managing first information relating to an offer target and acquired from the offer target and second information relating to the offer target and acquired from a source other than the offer target, the offer target being connected via a network; and
specifying an offering model relating to the offer target based on the first information and the second information.
